(19) United States
(12) Patent Application Publication
(10) Pub. No.: US 2016/0236959 A1
(43) Pub. Date: Aug. 18, 2016

(54) MOLTEN METAL BATH, PARTICULARLY A MOLTEN TIN BATH, OF A PRODUCTION LINE FOR PRODUCING FLAT GLASS, AND METHOD FOR LIMITING THE DIFFERENTIAL EXPANSION BETWEEN THE CROWN AND THE VAT

(71) Applicant: FIVES STEIN S.A., Maisons Alfort (FR)

(72) Inventors: Luc DERIBREUX, Saint-Andre (BE); Christian GEORGES, Franiere (BE); Marc DACHELET, Pessoux (BE)

(73) Assignee: Five Stein S.A., Maisons Alfort (FR)

(21) Appl. No.: 15/027,118

(22) PCT Filed: Oct. 6, 2014
(86) PCT No.: PCT/EP2014/071352

§ 371 Date: Apr. 4, 2016

(30) Foreign Application Priority Data
Oct. 7, 2013 (BE) 2013/0669

(51) Int. Cl. C03B 18/18; C03B 18/16

(52) U.S. Cl. CPC C03B 18/18; C03B 18/16

(57) ABSTRACT

A tin bath of a production line for producing flat glass, includes a crown (6) covering a vat (5), in which the liquid tin (10) is located. The crown (6) consists of a self-supporting structure (29) that rests directly on each side of the vat (5), on a supporting framework (25), via a limited, suitable number of sliding or rolling bearings (24). A method makes it possible to limit the longitudinal differential expansion between the crown (6) and the vat (5) such as to prevent deterioration of the luting seams (19) between the vat (5) and the crown (6) that can cause gas leaks between the bath environment and the outside of the vat. The method involves monitoring the longitudinal differential expansion between the vat and the crown by measuring the latter and adjusting the cooling of the vat such as to keep the differential expansion within defined limits.

### FIELD OF APPLICATION

The invention relates to the bath of molten metal, generally of tin, that is found in a production line for the continuous production of flat glass (float glass). This equipment placed between the furnace and the annealing lehr makes it possible to form the glass ribbon having the desired thickness and the desired width on a bath of molten metal, in particular of tin.

### TECHNICAL PROBLEM TO WHICH THE INVENTION PROVIDES A SOLUTION

The invention provides a solution for supporting the crown of a bath of molten metal, generally of tin, on a flat glass production line, which reduces or eliminates the risk of leakages appearing between the inside of the bath and the outside, leakages caused by different displacements between the roof and the bottom casing.

Indeed, any appearance of oxygen in the chamber of the tin bath, normally filled with a controlled gas atmosphere, mainly nitrogen with a certain proportion of hydrogen, is capable of creating oxides, especially tin oxides, which themselves participate in processes for generating defects on the glass sheet. To avoid this phenomenon, airtightness between the various parts constituting the chamber of the tin bath is achieved by what a person skilled in the art refers to as sealing, which is a joint created between two neighboring components. The contiguous surfaces produce a V-shaped notch filled by a special mortar that sets by drying, with or without the addition of ceramic fibers.

This sealing is deliberately fragile in order to allow the rapid dismantling of the airtight components, thanks to the breaking of the layer of mortar, for maintenance intervention purposes. This sealing must be reviewed frequently following the appearance of cracks which are due to differentiated movements between the tank containing the tin bath and the roof.

### PRIOR ART, IMPERFECTIONS OF THE PRIOR ART AND TECHNICAL PROBLEM TO BE SOLVED

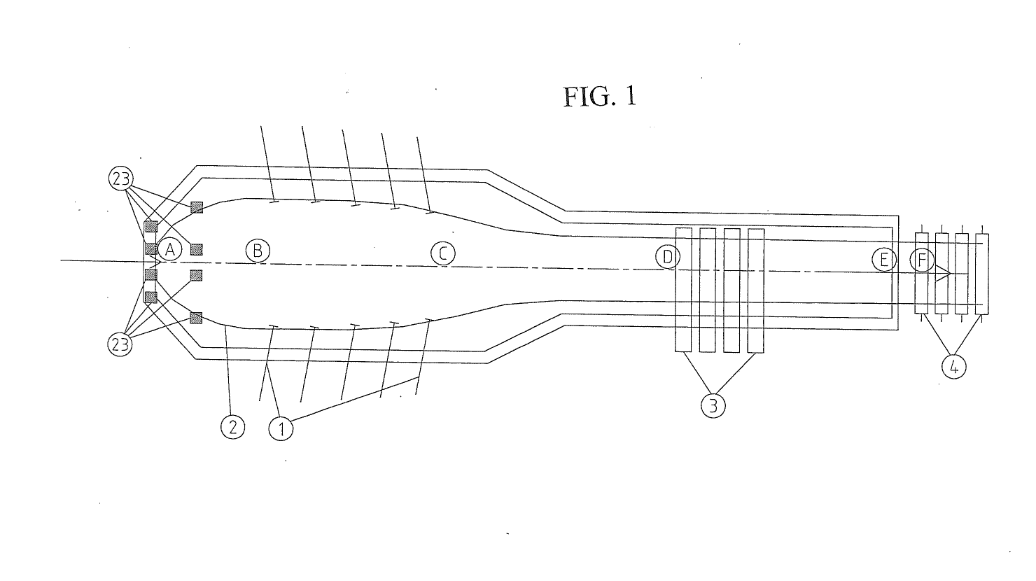

FIG. 1 presents, schematically in elevation, the prior art of the process for spreading a continuous flow of viscous glass onto a tin bath, in order to obtain a sheet with controlled thickness and width. The direction of the glass flow is indicated by arrows, from left to right. The glass is poured at a temperature where it flows in a viscous manner onto the molten metal and at constant flow rate at A. The layer of glass then spreads out naturally by gravity up to B, where auxiliary machines 1, referred to as top rollers, hold the edges of the sheet 2 so that the stretching caused by the annealing lehr at F results in a reduction in thickness without a reduction in width up to C, starting from which the reductions in width and in thickness are carried out substantially in the same proportion. Starting from D, the sheet thus formed is cooled, mainly by radiation, by means of coolers 3 overhanging it, in order to obtain a temperature sufficient to lift the glass ribbon from the tin bath at E and to remove it from the Tin bath towards the annealing lehr, consisting of successive rollers 4.

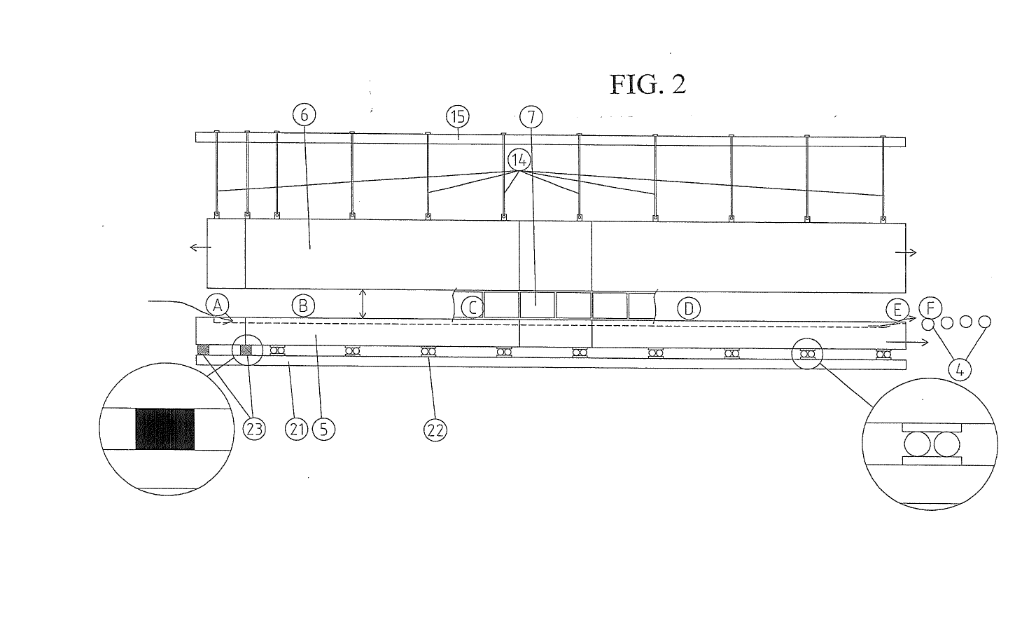

FIG. 2 presents a schematic side view of the same equipment and process, and shows that the whole of the process is carried out in a chamber formed of three main constituents, the bath casing 5 itself, the roof 6 overhanging it, and the side-sealing casings 7, also referred to as “side sealings”, creating the join between the two preceding components. Indeed, the whole of the process must be carried out under a protective atmosphere in order to avoid in particular the oxidation of the molten metal in the presence of air, and therefore the chamber must be sufficiently airtight with respect to the external atmosphere, but the inside of the chamber must be accessible to the operators at any location via the sides in order to introduce the various auxiliary equipment, or else to enable sheet guiding operations during the start-up of the process. The side casings 7 are therefore easily removable, and are simply laid on the lateral faces of the tank 5. Airtightness between the various parts constituting the chamber of the tin bath is achieved by what a person skilled in the art refers to as sealing, which is a joint created between two neighboring components, the contiguous faces of which produce a V-shaped notch that is filled by a special mortar that sets by drying, with or without the addition of ceramic fibers.

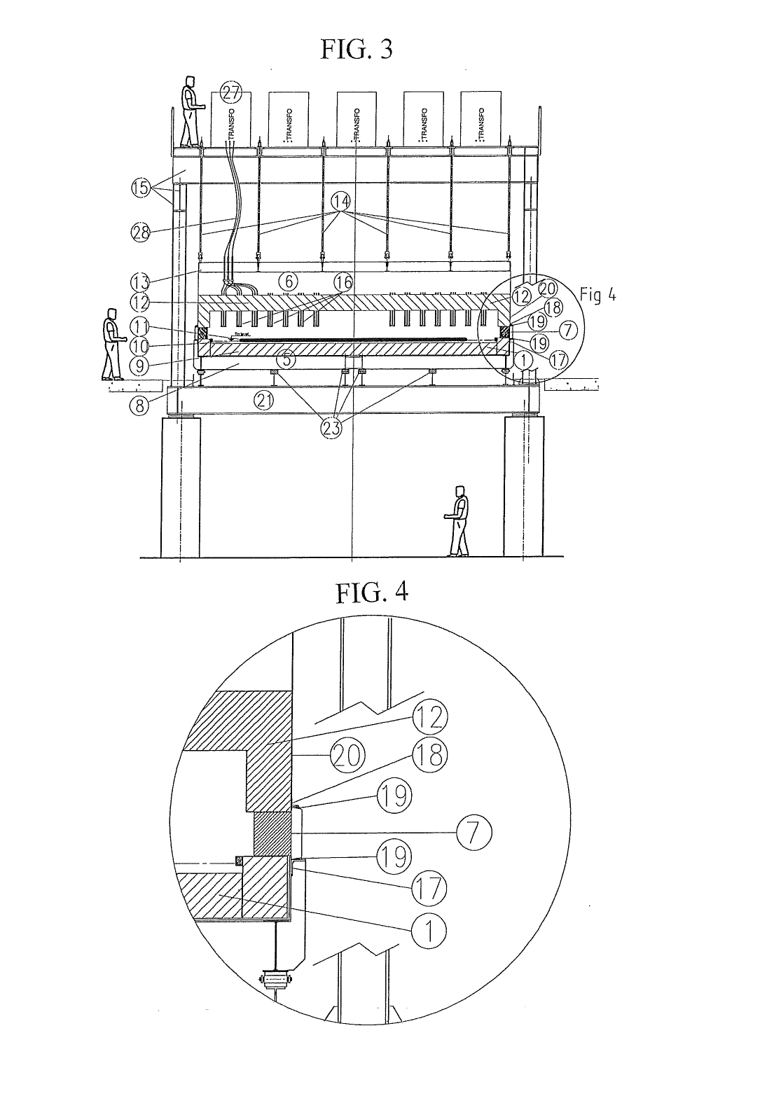

In a more detailed manner, FIG. 3 presents a cross section of the equipment and process according to the prior art at B. The bath casing 5 consists of a U shaped metal housing 8 packed with refractory material 9 that is also U shaped, which contains the molten metal 10, on which the glass sheet 11 is spread and formed. The roof 6, which overhangs the tank 5 and thus creates with it the chamber of the tin bath, is composed of a refractory packing 12 supported by a metallic structure 13 suspended by a multitude of hangers 14, of continuously adjustable length, from a frame 15 that overhangs the whole of the surface of the tin bath. Electrical heaters 16 are suspended in the crown 6 in order to maintain the bath temperature at the level necessary to ensure the metal 10 remains molten and to thermally condition the glass ribbon 11 in function of its thickness, its nature and the product to be produced.

On each section of the roof 6 of the tin bath, a set of 4 or 6 hangers 14 ensures the suspension of the crown during each phase of its life cycle: cold assembly, during the heating up of the bath, throughout the operating period of the bath and during the total or partial maintenance phases.

FIG. 4 is an enlargement of a portion from FIG. 3 that shows a typical junction between the roof 4 and the bath casing made of refractory material 1. The marker 7 presents the side casings, which are the closure elements between the roof 6 and the bath casing 5, also referred to as side sealings. These are metal boxes filled with thermally insulating material in order to reduce the heat losses to the outside and ensure a minimum of safety for the operators, by reduction of the contact temperature. The geometry of these side sealings enables the airtightness of the chamber of the bath to be achieved by the mortar and fibber sealing. More specifically, corners 17 are attached to the bath metal casing 8, and corners 18 are attached to the roof metal housing 20, forming with the side casings a V-shaped notch of horizontal axis, creating adequate space to receive the mortar and fibber joint 19. Similarly, between two consecutive side casings, a similar notch of vertical axis is formed so as to easily receive the sealing. These joints must be sufficiently airtight to minimize the losses of atmosphere and to prevent any inlet of air, while being sufficiently fragile to ensure easy and rapid dismantling in the case of necessary intervention in the chamber of the bath.

We understand, by analyzing FIGS. 1 and 2, that the particularly long bath tank 5, typically from 50 to 80 m in length, operating at high temperatures that vary as a function of the production conditions, typically from 140 to 220° C. for example, sees significant expansion in its metal portion 8, which imposes a particular assembly, that allows these expansions without constraints. Indeed, the metal casing 8 containing the tank is supported by an intermediate frame 21 rigidly fixed to the building and civil engineering foundations. The metal casing 8 is supported on this intermediate frame 21 by a multitude of sliding or rolling supports 22, with the exception of fixed supports 23 often referred to overall as “fixed points”, but in reality being more by a zone for rigidly connecting the casing 8 to the steel work 21. The rolling supports 22 enable the relative displacement of the casing 8 on the frame 21 along the axis of the process, but not in the lateral and vertical directions. Therefore, all of the thermal expansion of the tank is directed in the direction of the process.

In FIG. 2, it may be observed on the other hand that the suspension of the roof 6 by the multitude of hangers 14 gives a different result. This type of suspension allows the expansion of the crown in all horizontal directions, but comprises no transverse guiding or fixed point. For example, when the temperature of one side of the metal structure supporting the roof is sufficiently different from that of the other side, the differential thermal deformations may lead to lateral bending of the structure of the roof in the horizontal plane. The adjustments in the position and length of these hangers are particularly critical since any change of position deflects the axis of the hanger from its vertical position, and this angulation or offset causes a minimal but real disturbance of the true height of the roof 6 relative to the tank 5. Although the articulations of the hangers 14 relative to the frame 15 are provided in order to allow mainly displacements in the direction of the process, they are not however stiff enough to limit the deflections perpendicular to the direction of the process in the horizontal plane. Furthermore, the adjustments are difficult since it is ideally necessary to manipulate the hangers simultaneously, which is only carried out approximately in practice, by proceeding for example by groups of hangers that are close to one another.

However, the most inconvenient phenomenon is linked to the temperature differences on the one hand of the metal portion 8 containing the refractory tank 9 of the bath itself, and on the other hand of the metal structure 13 from which the roof is suspended. These temperature differences may lead to differential expansions, which are even greater since the expansion of the tank 5 along the axis of the process is guided and directed, whereas the expansion of the roof 6 takes place freely in all the directions of the horizontal plane.

Since the sealing 19 is produced based on a relatively fragile refractory mortar and fibber, the slightest variation in the geometry of the joint is capable of creating cracks and therefore an inlet of outside air that may give rise to the oxidation of the bath and thus create potential defects in the product. It is therefore sometimes necessary to act on the hangers in such a way that the movements due to the expansion of the roof in all directions are compensated. This operation is tricky and comprises the risk of lowering the roof 6 too far and ending up blocking the side casings, which may make difficult or prevent their removal during urgent operations, for the recovery of the ribbon in the event of rupture of the ribbon in the bath for example. The operation for adjusting the height of the roof is therefore complicated and requires sufficient personnel since the adjustment must take place simultaneously on the various tie rods.

During the heating up of the bath, it is understood that the difference in expansion of the metal support structures 8 and of the metal portion of the roof of the bath 4 will lead to a misalignment of the hangers, the position of which will move away from the vertical position, which will create a shearing effect on the joint in the horizontal plane and move the roof 4 away from its initial vertical position as preset at the start-up of the plant. This vertical movement of the crown 4 or its horizontal movement or any combination of these two movements may create a shearing or a local deterioration of the joint 19, which creates leakages between the atmosphere of the bath and the outside of the float bath. These leakages may lead to an oxidation of the tin bath and the appearance of quality defects on the glass.

It is therefore necessary to install a device for supporting the roof 6 that ensures its precise positioning relative to the tank 1 and that avoids displacements of the roof in the vertical and horizontal directions in order to ensure the airtightness thereof in order to eliminate the risk of the appearance of leakages, including during changes in thermal regimes of the bath that modify the expansion of the various portions of the roof support, in particular the steel frame that overhangs the roof and all of the hangers.

### DETAILED DESCRIPTION OF THE INVENTION

The invention consists firstly of a roof resting on sliding or rolling supports that guide and direct the thermal expansions of the whole of the roof along the direction of the process, and comprising a “fixed point” in the vicinity of the perpendicular to the fixed point of the tank.

The invention also consists of a process for controlling the thermal expansions of the bath casing and of the roof, so as to eliminate or reduce the differences in expansions of the two assemblies, and therefore to eliminate or reduce the stresses on the sealing.

According to the invention, a tin bath of a production line for producing float glass comprising a roof covering a tank in which liquid tin is found, is characterized in which the roof concerns by a “fixed point” in the vicinity of the perpendicular axis to the “fixed point” of the tank.

More specifically, according to the invention, a bath of molten metal, in particular of tin, of a production line for producing float glass comprises a chamber formed of three main constituents, a bath tank, in which liquid metal, in particular tin, is found, a roof overhanging it, and side-sealing casings, creating the join between the two preceding components, the bath tank consisting of a metal casing, packed with refractory material, that may be moved on a frame along the axis of the process, with the exception of fixed supports, referred to as “fixed points”, formed by a zone for rigidly connecting the casing to the steel frame, and is characterized in that the crown rests on sliding or rolling supports that guide and direct the thermal expansions of the whole of the crown along the direction of the process, and comprises a “fixed point” in the vicinity of the perpendicular axis to the “fixed point” of the tank.

The axis, or the direction, of the process are synonymous with the axis, or the direction, of feed motion of the glass ribbon.

The invention relates to a solution to the differential expansions of two main metal structures, of the tank and of the roof, in the form of casings. The expansions of refractory materials contained inside these casings are treated by hangers for the crown refractory materials and by a dowel assembly with expansion joints for the bottom, or tank, refractory materials.

Advantageously, the roof consists of a self-supporting structure which rests directly, on each side of the tank, on a support frame, by means of a limited and suitable number of sliding or rolling supports.

The self-supporting structure of the roof does not create shear stresses on the lateral structure, consisting of the support frame, which only takes up vertical stresses.

The displacement of the roof which results from its expansion may be guided by a guiding system integrated into the supports. As a variant, the displacement of the roof which results from its expansion may be guided by a guiding system external to the supports.

The roof “fixed point” may consist of a zone for rigidly connecting the crown to a frame, which is firmly attached to the frame that supports the tank.

Advantageously, the transformers for powering the electrical heaters for heating the crown rest directly on the self-supporting structure of the roof.

The metal bath, in particular tin bath, of a production line for producing float glass may comprise a gantry crane that enables the rapid assembly and dismantling of sections of the roof, and also the handling operations for the assembly and repair of equipment of the metal bath.

The invention also relates to a process that makes it possible to limit the differential expansions between a tank and a roof of a bath of molten metal, in particular of tin, of a production line for producing float glass, so as to prevent the degradation of the sealing joints between the tank and the roof that may give rise to gas leakages between the atmosphere of the bath and the outside of the tank, which process is characterized in that it consists in monitoring the longitudinal differential expansion between the roof and the tank by a continuous measurement thereof and in adjusting the cooling of the tank so as to keep the longitudinal differential expansion within defined limits.

More specifically, according to the invention, the process that makes it possible to limit the differential expansions between a tank and a roof of a bath of molten metal, in particular of tin, of a production line for producing float glass, when side-sealing casings create the join between the two preceding components, the bath tank consisting of a metal casing, packed with refractory material, that may be moved on a frame along the axis of the process, with the exception of fixed supports, referred to as “fixed points”, formed by a zone for rigidly connecting the casing to the frame, the crown resting on sliding or rolling supports that guide and direct the thermal expansions of the whole of the crown along the direction of the process, and comprising a “fixed point” in the vicinity of the perpendicular axis to the “fixed point” of the tank, which process is characterized in that it consists in monitoring the longitudinal differential expansion between the roof and the tank by a continuous measurement thereof and in adjusting the cooling of the tank so as to keep the longitudinal differential expansion within defined limits, so as to prevent the degradation of the sealing joints between the tank and the roof that may give rise to gas leakages between the atmosphere of the bath and the outside of the tank.

The measurement of the longitudinal differential expansion between the roof and the tank may be carried out by means of expansion sensors.

Advantageously, the longitudinal differential expansion is maintained at less than ±0.05 mm/m.

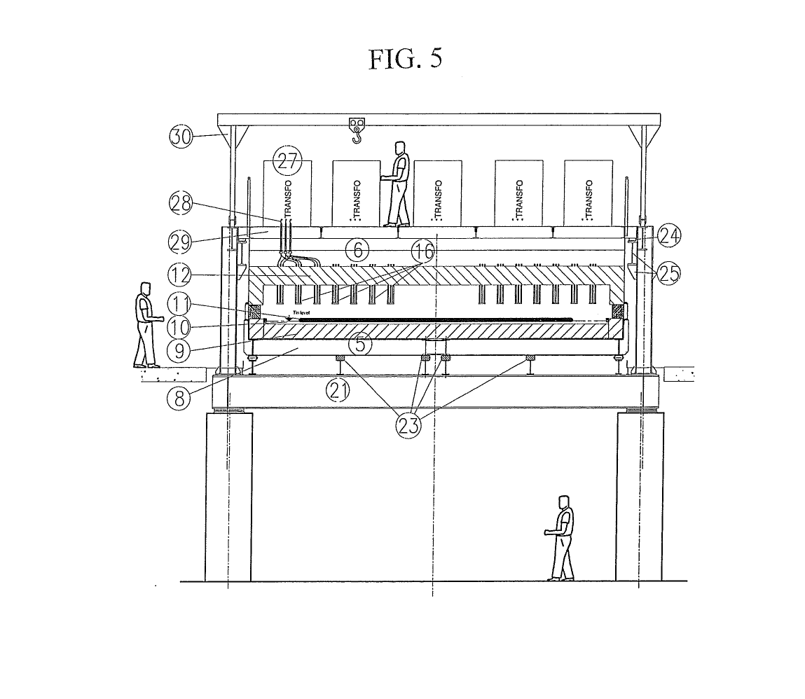

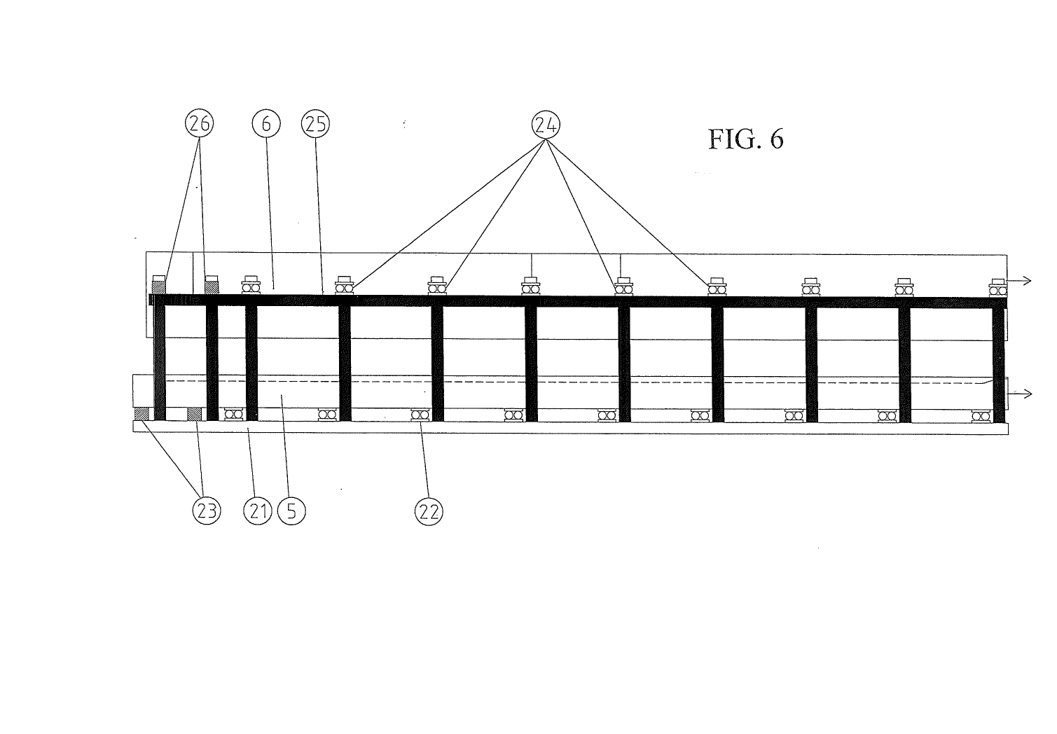

The invention consists, apart from the arrangements set out above, of a certain number of other arrangements, which will be mentioned more explicitly below with reference to FIGS. 5 and 6, schematic representations in cross section and as a side view of a tin bath that is a nonlimiting exemplary embodiment of the invention.

Represented in FIGS. 5 and 6 it can be seen that according to the invention the metal structure that overhangs the tin bath and also the hangers 14 are eliminated in favor of a more compact support system, consisting of a frame 25 placed on either side of the tank and firmly attached to the steel frame 21 for supporting the tank 5. It is on this frame 25 that the metal structure of the roof directly slides or rolls, by means of rolling or sliding supports 24. These rolling or sliding supports may also be guiding, in the sense that they allow, in the horizontal plane, an easy and unconstrained relative displacement in the direction of the process, without allowing lateral displacement. However, the lateral guiding of the roof 6 may also be carried out by means external to the sliding or rolling supports 24. The metal structure 29 of the roof is reinforced relative to the prior art in order to be self-supporting over the width of the tin bath. The influence of the expansions and offsets of the hangers has been eliminated. The existence of a roof “fixed point” 26, in reality a zone 26 for rigidly connecting the roof 6 to the steel frame 25, perpendicular to the “fixed point” 23 of the tank, ensures that these two roof and tank assemblies are rigidly connected and that in this zone the sealing cannot be subjected to any stress in the horizontal plane.

During different production regimes, different temperature regimes exist in the roof and the bath, the respective temperatures of their metal structures may be different and may give rise to a different expansion of each assembly, which is a source of stresses and, ultimately, cracks in the sealing. In order to prevent any differential horizontal displacement between tank and roof, it is possible to act on the tank temperature by continuously adapting the forced cooling thereof, so as to maintain the longitudinal differential expansion of the metal structure of the tank of the bath relative to that of the roof, within a strict tolerance. In order to drive the forced cooling and regulate the differential expansions, an automatism may monitor not only temperatures, but also, by means of expansion sensors, the displacements both of the tank and of the roof. As may be observed, this control method cannot be carried out with a hangers suspension system according to the prior art.

It is also seen on FIG. 5 that the upper part of the roof according to the invention is completely free of any structural element (presence of process elements only such as thermocouples, sight holes, cameras, transformers, etc.). The absence of hangers therefore makes the siting of this equipment and the access completely free.

This free access above the roof according to FIG. 5 also enables the installation of electric transformers 27 for powering the heaters 16 directly above the roof, which makes it possible to considerably reduce the length of the secondary cables 28 which also reduces their electrical losses by the Joule effect. The secondary cables are conventionally powered by low voltages (generally less than 100 volts) and with a high current. The elimination or reduction in the length thereof allows an energy saving of the order of 0.5% of the total consumption necessary for heating the bath.

The elimination of the upper frame 15 and of the hangers 14 also enables the use of equipment handling means such as an integrated mobile crane 30 or the use, without risk of interference, of an overhead travelling crane integrated into the building. The integrated mobile crane 30 may be used for positioning the roof sections and also for the installation of the transformers 27. Since this crane is permanent, it may also be used during cold repair operations or in case of a serious incident regarding the bath (hot repair operations).

The invention allows, during the initial assembly, a complete assembly of the frame of the bath without however disturbing the installation of the roof subsequently. The elimination, according to the invention, of the portion of the metal structure used for suspending the roof by the hangers, makes it possible to reduce the necessary height of the building. The installation of walkways allows access to the equipment for controlling and operating the bath.

1-10. (canceled)

11. A metal bath, in particular a tin bath, of a production line for producing float glass comprising a chamber formed of three main constituents, a bath tank (5), wherein liquid metal, in particular liquid tin (10), is found, a roof (6) overhanging it, and side-sealing casings (7), creating the join between the two preceding components, the bath tank (5) comprising a metal casing (8) packed with refractory material (9) , that may be moved on a frame (21) along the axis of the process, with the exception of fixed supports (23) referred to as “fixed points”, formed by a zone for rigidly connecting the casing to the frame (21), wherein the roof (6) rests on sliding or rolling supports (24) that guide and direct the thermal expansions of the whole of the roof along the axis of the process, and comprises a “fixed point” (26) in the vicinity of the perpendicular to the “fixed point” (23) of the tank (5).

12. The metal bath, in particular tin bath, of a production line for producing float glass as claimed in claim 11, wherein the crown “fixed point” consists of a zone (26) for rigidly connecting the crown (6) to a frame (25), which is firmly attached to the frame (21) that supports the tank (5).

13. The metal bath, in particular tin bath, of a production line for producing float glass as claimed in claim 11, wherein the roof (6) consists of a self-supporting structure (29) which rests directly, on each side of the tank (5), on the support frame (25), by means of a limited and suitable number of sliding or rolling supports (24).

14. The metal bath, in particular tin bath, of a production line for producing float glass as claimed in claim 11, wherein the displacement of the roof (6) which results from its expansion is guided by a guiding system integrated into the supports (24).

15. The metal bath, in particular tin bath, of a production line for producing float glass as claimed in claim 11, wherein the displacement of the roof (6) which results from its expansion is guided by a guiding system external to the supports (24).

16. The metal bath, in particular tin bath, of a production line for producing float glass as claimed in claim 13, wherein the transformers (27) for powering the electrical heaters for heating the roof rest directly on the self-supporting structure (29) of the roof.

17. The metal bath, in particular tin bath, of a production line for producing float glass as claimed in claim 11, further comprising a crane (30) that enables the rapid assembly and dismantling of sections of the roof (6), and also the handling operations for the assembly and repair of equipment of the tin bath.

18. A process that makes it possible to limit the differential expansions between a tank (5) and a roof (6) of a metal bath, in particular tin bath, of a production line for producing float glass, side-sealing casings (7) creating the join between the two preceding components, the bath tank (5) consisting of a metal casing (8) packed with refractory material (9), that may be moved on a frame (21) along the axis of the process, with the exception of fixed supports (23) referred to as “fixed points”, formed by a zone for rigidly connecting the casing (8) to the frame (21), the roof (6) resting on sliding or rolling supports (24) that guide and direct the thermal expansions of the whole of the crown along the axis of the process, and comprising a “fixed point” (26) in the vicinity of the perpendicular to the “fixed point” (23) of the tank (5), wherein the process comprises monitoring the longitudinal differential expansion between the roof (6) and the tank (5) by a continuous measurement thereof, and adjusting the cooling of the tank so as to keep the longitudinal differential expansion within defined limits, so as to prevent the degradation of sealing joints (19) between the tank (5) and the roof (6) that may give rise to gas leaks between the atmosphere of the bath and the outside of the tank.

19. The process as claimed in claim 18, wherein the measurement of the longitudinal differential expansion between the roof (6) and the tank (5) is carried out by means of expansion sensors.

20. The process as claimed in claim 18, wherein the longitudinal differential expansion is maintained at less than ±0.05 mm/m.

21. The metal bath, in particular tin bath, of a production line for producing float glass as claimed in claim 12, wherein the roof (6) consists of a self-supporting structure (29) which rests directly, on each side of the tank (5), on the support frame (25), by means of a limited and suitable number of sliding or rolling supports (24).

22. The metal bath, in particular tin bath, of a production line for producing float glass as claimed in claim 12, wherein the displacement of the roof (6) which results from its expansion is guided by a guiding system integrated into the supports (24).

23. The metal bath, in particular tin bath, of a production line for producing float glass as claimed in claim 13, wherein the displacement of the roof (6) which results from its expansion is guided by a guiding system integrated into the supports (24).

24. The metal bath, in particular tin bath, of a production line for producing float glass as claimed in claim 12, wherein the displacement of the roof (6) which results from its expansion is guided by a guiding system external to the supports (24).

25. The metal bath, in particular tin bath, of a production line for producing float glass as claimed in claim 13, wherein the displacement of the roof (6) which results from its expansion is guided by a guiding system external to the supports (24).

26. The metal bath, in particular tin bath, of a production line for producing float glass as claimed in claim 12, further comprising a crane (30) that enables the rapid assembly and dismantling of sections of the roof (6), and also the handling operations for the assembly and repair of equipment of the tin bath.

27. The metal bath, in particular tin bath, of a production line for producing float glass as claimed in claim 13, further comprising a crane (30) that enables the rapid assembly and dismantling of sections of the roof (6), and also the handling operations for the assembly and repair of equipment of the tin bath.

28. The process as claimed in claim 19, wherein the longitudinal differential expansion is maintained at less than ±0.05 mm/m.
